(19) United States
(12) Patent Application Publication
(10) Pub. No.: US 2008/0233876 A1
(43) Pub. Date: Sep. 25, 2008

(54) METHOD AND SYSTEM FOR SHARING AN AUDIO PROCESSOR IN AN INTEGRATED FM RADIO AND BLUETOOTH SYSTEM

(76) Inventor: Bojko Marholev, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 12/031,261

(22) Filed: Feb. 14, 2008

Related U.S. Application Data
(60) Provisional application No. 60/895,665, filed on Mar. 19, 2007.
(60) Provisional application No. 60/895,667, filed on Mar. 19, 2007.

(51) Int. Cl. H04B 7/00

(52) U.S. Cl. 455/41.2

(57) ABSTRACT

Aspects of a method and system for sharing an audio processor in an integrated FM and Bluetooth system are provided. In this regard, the shared audio processor may be enabled to process Bluetooth audio signals and/or FM audio signals. The shared audio processor may enable A/D conversion, D/A conversion, and/or conversion between digital audio formats. The shared audio processor may process signals from a FM radio receiver, a Bluetooth receiver, a FM radio transmitter, and/or a Bluetooth transmitter. The shared audio processor may process analog and/or digital signals, and may process encoded signals.

### CROSS-REFERENCE TO RELATED APPLICATIONS/INCORPORATION BY REFERENCE

This patent application makes reference to, claims priority to and claims benefit from U.S. Provisional Patent Application Ser. No. 60/895,665 filed on Mar. 19, 2007.

This patent application makes reference to, claims priority to and claims benefit from U.S. Provisional Patent Application Ser. No. 60/895,667 filed on Mar. 19, 2007.

Each of the above stated applications is hereby incorporated herein by reference in its entirety.

### FIELD OF THE INVENTION

Certain embodiments of the invention relate to signal processing. More specifically, certain embodiments of the invention relate to a method and system for sharing an audio processor in an integrated FM radio and Bluetooth system.

### BACKGROUND OF THE INVENTION

With the popularity of portable electronic devices and wireless devices that support audio applications, there is a growing need to provide a simple and complete solution for audio communications applications. For example, some users may utilize Bluetooth-enabled devices, such as headphones and/or speakers, to allow them to communicate audio data with their wireless handset. Other users may have portable electronic devices that may enable them to play stored audio content and/or receive audio content via FM broadcast communication, for example.

However, incorporating multiple audio communication technologies into a single device may be costly. Combining a plurality of different communication services into a portable electronic device or a wireless device may require separate processing hardware and/or separate processing software. Moreover, coordinating the reception and/or transmission of data to and/or from the portable electronic device or a wireless device may require significant processing overhead that may impose certain operation restrictions and/or design challenges. Furthermore, simultaneous use of a plurality of radios in a handheld may result in significant increases in power consumption.

Another complication associated with incorporating multiple wireless technologies in a single device is that each radio often requires a number of components for signal processing. Consequently, space may quickly become limited as each processing block may require a significant amount of area.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for sharing an audio processor in an integrated FM radio and Bluetooth system, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary FM radio transmitter and FM radio receiver that communicate with handheld devices that utilize a single chip with integrated Bluetooth and FM radios, in accordance with an embodiment of the invention.

FIG. 2 is a block diagram of an exemplary single chip that supports Bluetooth and FM radio operations, in accordance with an embodiment of the invention.

FIG. 3A is a block diagram of a shared audio processor in an integrated FM radio and Bluetooth system, in accordance with an embodiment of the invention.

FIG. 3B is a diagram of an exemplary integrated audio processor, in accordance with an embodiment of the invention.

FIG. 4A illustrates exemplary steps for processing audio received audio via an integrated FM radio receiver utilizing a shared audio processor, in accordance with an embodiment of the invention.

FIG. 4B illustrates exemplary steps for processing audio received audio via an integrated BT receiver utilizing a shared audio processor, in accordance with an embodiment of the invention.

FIG. 4C illustrates exemplary steps for processing audio received audio via an integrated PTU utilizing a shared audio processor, in accordance with an embodiment of the invention.

### DETAILED DESCRIPTION OF THE INVENTION

Certain embodiments of the invention may be found in a method and system for sharing an audio processor in an integrated FM radio and Bluetooth system. In this regard, the shared audio processor may be enabled to process Bluetooth audio signals and/or FM audio signals. The shared audio processor may enable A/D conversion, D/A conversion, and/or conversion between digital audio formats. The shared audio processor may process signals from a FM radio receiver, a Bluetooth receiver, a FM radio transmitter, and/or a Bluetooth transmitter. The shared audio processor may process analog and/or digital signals. The shared audio processor may process encoded signals.

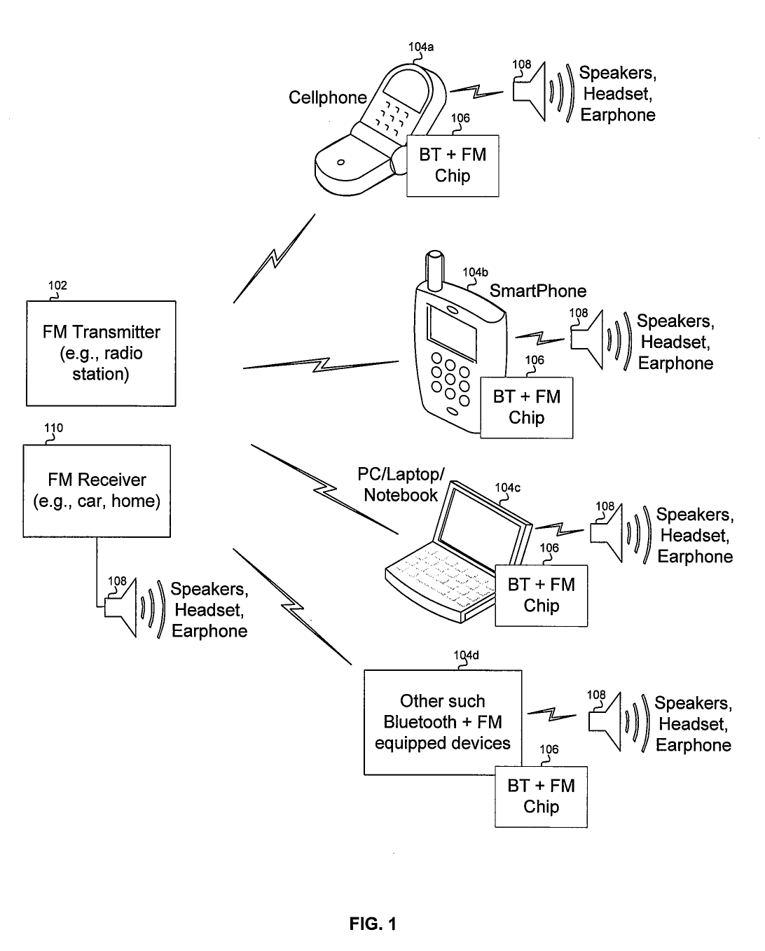

FIG. 1 is a block diagram of an exemplary FM radio transmitter and FM radio receiver that communicate with handheld devices that utilize a single chip with integrated Bluetooth and FM radios, in accordance with an embodiment of the invention. Referring to FIG. 1A, there is shown an FM radio transmitter 102, an FM radio receiver 110, a cellular phone 104a, a smart phone 104b, a computer 104c, and an exemplary FM radio and Bluetooth-equipped device 104d. The FM radio transmitter 102 may be implemented as part of a radio station or other broadcasting device, for example. Each of the cellular phone 104a, the smart phone 104b, the computer 104c, and the exemplary FM radio and Bluetooth-equipped device 104d may comprise a single chip 106 with integrated Bluetooth and FM radios for supporting FM radio and Bluetooth data communications. The FM radio transmitter 102 may enable communication of FM radio audio data to the devices shown in FIG. 1A by utilizing the single chip 106. Similarly, the single chip 106 may enable the transmission of audio and/or data via Bluetooth communication to/from the listening devices 108.

The cellular phone 104a may be enabled to receive an FM radio transmission signal from the FM radio transmitter 102. The cellular phone 104a may then re-transmit the data, via Bluetooth, to the listening device 108. The cellular phone 104a may comprise a “one-touch” programming feature that enables pulling up specifically desired broadcasts, like weather, sports, stock quotes, or news, for example. The smart phone 104b may be enabled to receive an FM radio transmission signal from the FM radio transmitter 102. The smart phone 104b may then re-transmit the data, via Bluetooth, to the listening device 108.

The computer 104c may be a desktop, laptop, notebook, tablet, and a PDA, for example. The computer 104c may be enabled to receive an FM radio transmission signal from the FM radio transmitter 102. The computer 104c may then re-transmit the data, via Bluetooth, to the listening device 108. The computer 104c may comprise software menus that configure listening options and enable quick access to favorite options, for example. In one embodiment of the invention, the computer 104c may utilize an atomic clock FM signal for precise timing applications, such as scientific applications, for example. While a cellular phone, a smart phone, computing devices, and other devices have been shown in FIG. 1A, the single chip 106 may be utilized in a plurality of other devices and/or systems that receive and use Bluetooth and/or FM radio signals. In one embodiment of the invention, the single chip Bluetooth and FM radio may be utilized in a system comprising a WLAN radio.

Accordingly, the single chip 106 may comprise aspects of the invention that may enable sharing an audio processor between integrated FM radio and Bluetooth radios. In this manner, audio received via an FM radio signal and audio data to be transmitted via a Bluetooth signal, for example, may be processed by the same audio processor. Consequently, circuit area and power consumption, for example, may be reduced for the single chip 106.

The FM radio receiver 110 may comprise and/or may be communicatively coupled to a listening device 108. A device equipped with the Bluetooth and FM radio transceivers, such as the single chip 106, may be able to broadcast its respective signal to a “deadband” of an FM radio receiver for use by the associated audio system. For example, a cellphone or a smart phone, such as the cellular phone 104a and the smart phone 104b, may transmit a telephone call for listening over the audio system of an automobile, via usage of a deadband area of the car's FM stereo system. One advantage may be the universal ability to use this feature with all automobiles equipped simply with an FM radio with few, if any, other external FM radio transmission devices or connections being required.

In another example, a computer, such as the computer 104c, may comprise an MP3 player or another digital music format player and may broadcast a signal to the deadband of an FM radio receiver in a home stereo system. The music on the computer may then be listened to on a standard FM radio receiver with few, if any, other external FM radio transmission devices or connections. While a cellular phone, a smart phone, and computing devices have been shown, a single chip that combines a Bluetooth and FM radio transceiver and/or receiver may be utilized in a plurality of other devices and/or systems that receive and use an FM radio signal.

Accordingly, the single chip 106 may comprise aspects of the invention that may enable sharing an audio processor between integrated FM radio and Bluetooth radios. In this manner, audio received via a Bluetooth signal and audio data to be transmitted via an FM radio signal, for example, may be processed by the same audio processor. Consequently, circuit area and power consumption, for example, may be reduced for the single chip 106.

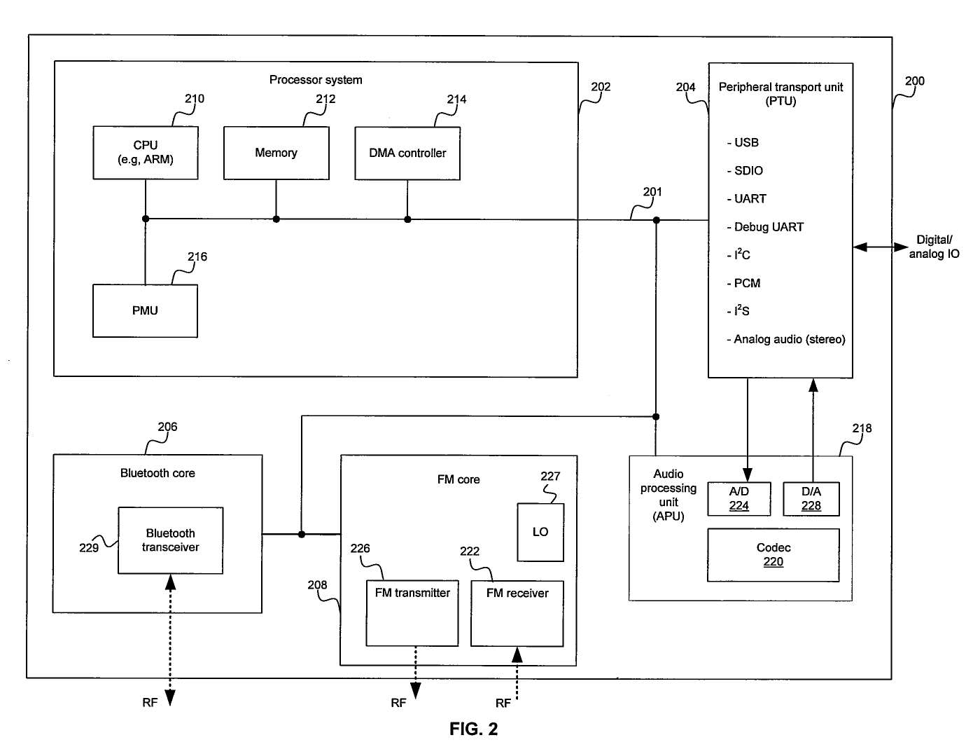

FIG. 2 is a block diagram of an exemplary single chip that supports Bluetooth and FM radio operations, in accordance with an embodiment of the invention. Referring to FIG. 2, there is shown a single chip 200 that may comprise a processor system 202, a peripheral transport unit (PTU) 204, a Bluetooth core 206, a frequency modulation (FM) radio core 208, an audio processing unit (APU) 218, and a common bus 201.

The processor system 202 may comprise a central processing unit (CPU) 210, a memory 212, a direct memory access (DMA) controller 214, and a power management unit (PMU) 216.

The APU 218 may comprise a codec 220, an analog-to-digital converter (A/D) 224, and a digital-to-analog (D/A) converter 228. At least a portion of the components of the processor system 202 may be communicatively coupled via the common bus 201.

The CPU 210 may comprise suitable logic, circuitry, and/or code that may enable control and/or management operations in the single chip 200. In this regard, the CPU 210 may communicate control and/or management operations to the Bluetooth core 206, the FM radio core 208, and/or the PTU 204 via a set of register locations specified in a memory map. Moreover, the CPU 210 may be utilized to process data received by the single chip 200 and/or to process data to be transmitted by the single chip 200. The CPU 210 may enable processing of data received via the Bluetooth core 206, via the FM radio core 208, and/or via the PTU 204. For example, the CPU 210 may enable processing of A2DP data received from the Bluetooth core 206 via the common bus 201. The CPU 210 may then transfer the processed A2DP data to other components of the single chip 200 via the common bus 201. In this regard, the CPU 210 may utilize the codec 220 in the APU 218 to encode and/or decode A2DP data, for example. The CPU 210 may enable processing of data to be transmitted via the Bluetooth core 206, via the FM radio core 208, and/or via the PTU 204. The CPU 210 may be, for example, an ARM processor or another embedded processor core that may be utilized in the implementation of system-on-chip (SOC) architectures.

The CPU 210 may also enable configuration of data routes to and/or from the FM radio core 208. For example, the CPU 210 may configure the FM radio core 208 so that data may be routed via an I²S interface or a PCM interface in the PTU 204 to one or more analog ports communicatively coupled to the PTU 204.

The CPU 210 may enable a host controller interface (HCI) in Bluetooth. In this regard, the HCI may provide a command interface to the baseband controller and link manager, and access to hardware status and control registers. The HCI may provide a method of accessing the Bluetooth baseband capabilities that may be supported by the CPU 210.

The memory 212 may comprise suitable logic, circuitry, and/or code that may enable data storage. In this regard, the memory 212 may be utilized to store data that may be utilized by the processor system 202 to control and/or manage the operations of the single chip 200. The memory 212 may also be utilized to store data received by the single chip 200 via the PTU 204, the Bluetooth core 206, and/or the FM radio core 208. Similarly, the memory 212 may be utilized to store data to be transmitted by the single chip 200 via the PTU 204, the Bluetooth core 206, and/or the FM radio core 208. The DMA controller 214 may comprise suitable logic, circuitry, and/or code that may enable transfer of data directly to and from the memory 212 via the common bus 201 without involving the operations of the CPU 210.

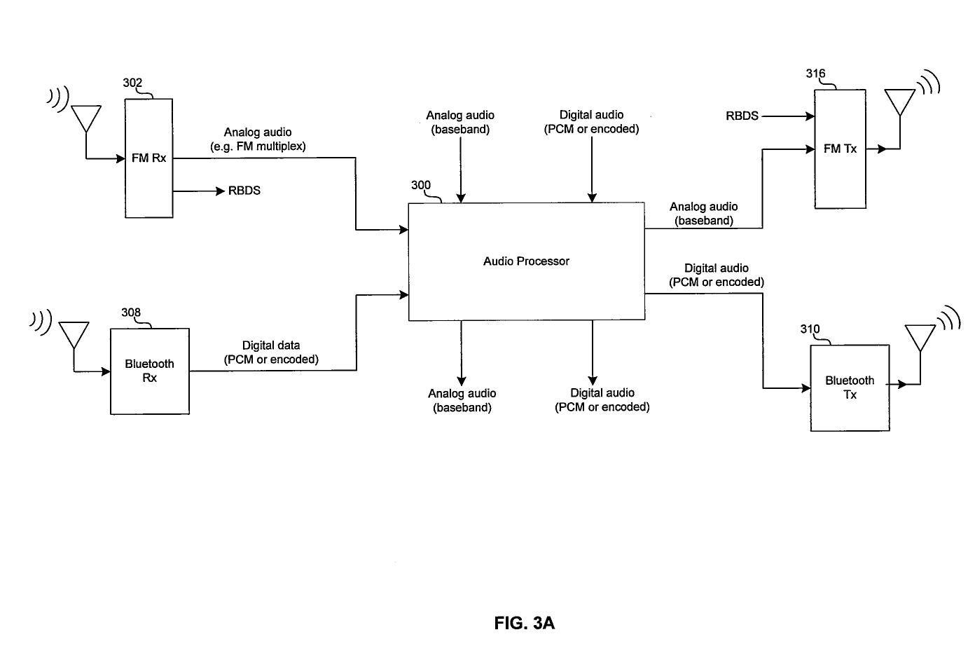

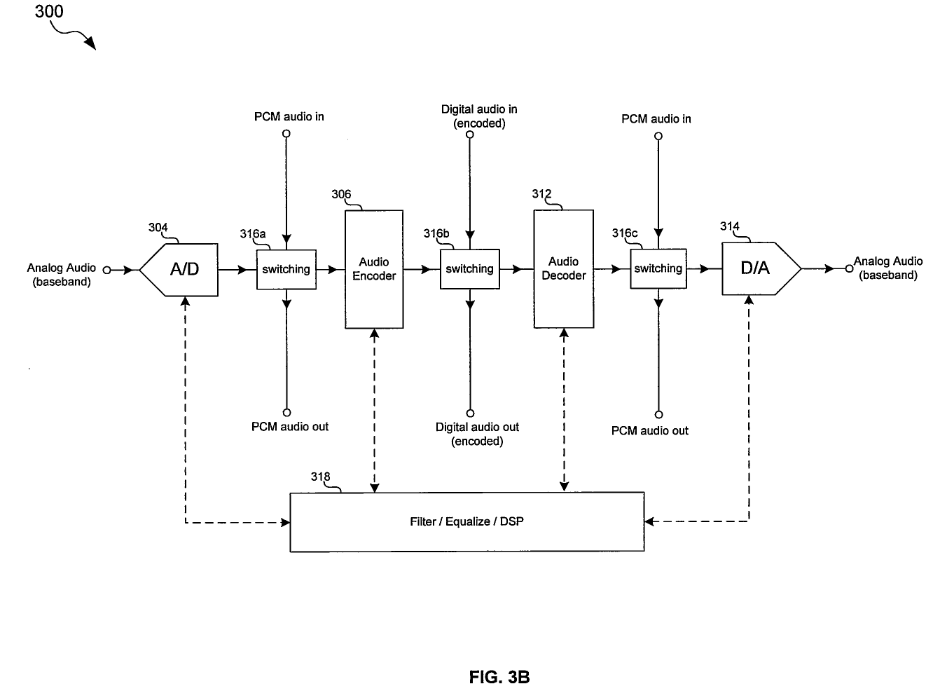

The APU218 may comprise suitable logic, circuitry, and/or code that may enable processing analog and/or digital audio signal. In this regard, the codec may enable coding and/or decoding audio signals to/from various formats. The A/D converter 224 may enable digitizing an analog audio signal. The D/A converter may enable outputting an analog audio signal from a digital audio bitstream. Additionally details of an exemplary APU are described in FIG. 3A and FIG. 3B.

The PTU 204 may comprise suitable logic, circuitry, and/or code that may enable communication to and from the single chip 200 via a plurality of communication interfaces. In some instances, the PTU 204 may be implemented outside the single chip 200, for example. The PTU 204 may support analog and/or digital communication with at least one port. For example, the PTU 204 may support at least one universal series bus (USB) interface that may be utilized for Bluetooth data communication, at least one secure digital input/output (SDIO) interface that may also be utilized for Bluetooth data communication, at least one universal asynchronous receiver transmitter (UART) interface that may also be utilized for Bluetooth data communication, at least one I²C bus interface that may be utilized for FM radio control and/or FM radio and RDS/RBDS data communication, and at least one analog audio interface that may be used for audio signal communication. The PTU 204 may also support at least one PCM interface that may, for example, be utilized for Bluetooth data communication and/or FM radio data communication.

The Bluetooth core 206 may comprise suitable logic, circuitry, and/or code that may enable reception and/or transmission of Bluetooth data. The Bluetooth core 206 may comprise a Bluetooth transceiver 229 that may perform reception and/or transmission of Bluetooth data. In this regard, the Bluetooth core 206 may support amplification, filtering, modulation, and/or demodulation operations, for example. The Bluetooth core 206 may enable data to be transferred from and/or to the processor system 202, the PTU 204, the APU 218, and/or the FM radio core 208 via the common bus 201, for example.

The FM radio core 208 may comprise suitable logic, circuitry, and/or code that may enable reception and/or transmission of FM radio data. The FM radio core 208 may comprise an FM radio receiver 222, an FM radio transmitter 226 and a local oscillator (LO) 227. The FM radio receiver 222 may support amplification, mixing, filtering, and/or demodulation operations, for example. The FM radio transmitter 226 may support modulation, filtering, mixing, and/or amplification operations, for example. The LO 227 may be utilized to generate a reference signal that may be utilized by the FM radio core 208 for performing analog and/or digital operations. The FM radio core 208 may be enabled to receive, via the shared bus 101, analog and/or digital data from the PTU 204, the Bluetooth core 206, the APU 218, and/or the processor system 202. In this regard, the FM core may transmit data received from the various blocks of the chip 200 to remote FM radio receivers. The FM radio core may be enabled to pass analog and/or digital audio and/or data to the PTU 204, the Bluetooth core 206, the APU 218, and/or the processor core 202. In this regard, the FM radio core 208 may receive data from a remote FM radio transmitter and may pass the data, via the shared bus 101, to the various blocks of the chip 200.

The FM radio core 208 may enable radio transmission and/or reception at various frequencies, in a range of about 76 MHz to 108 MHz, for example.

The FM radio core 208 may also enable reception of RDS data and/or RBDS data for in-vehicle radio receivers, for example. In this regard, the FM radio core 208 may enable filtering, amplification, and/or demodulation of the received RDS/RBDS data. The RDS/RBDS data may comprise, for example, a traffic message channel (TMC) that provides traffic information that may be communicated and/or displayed to an in-vehicle user. The RDS/RBDS data may be buffered in the memory 212 in the processor system 202. The RDS/RBDS data may be transferred from the memory 212 via the I²C interface when the CPU 210 is in a sleep or stand-by mode. For example, the FM radio core 208 may post RDS data into a buffer in the memory 212 until a certain level is reached and an interrupt is generated to wake up the CPU 210 to process the RDS/RBDS data. When the CPU 210 is not in a sleep mode, the RDS data may be transferred to the memory 212 via the common bus 201, for example. Moreover, the RDS/RBDS data received via the FM radio core 208 may be transferred to the PTU 204, the Bluetooth core 206, and/or the APU 218.

Digital circuitry within the FM radio core 208 may be operated based on a clock signal generated by dividing down a signal generated by the LO 227. The LO 227 may be programmable in accordance with the various channels that may be received by the FM radio core 208 and a divide ratio may be varied in order to maintain the digital clock signal close to a nominal value.

In operation, the chip 200 may receive FM radio signals via the FM radio core 208. In this regard, the FM radio core may process received FM radio signals and may make any resulting analog and/or digital audio and/or data available to the chip 200. In this regard, received FM radio signals may, for example, comprise stereo audio signals and RBDS data. The chip 200 may re-transmit the received information via the PTU 204, the Bluetooth core 206, the APU 218, and/or the FM radio transmitter 208. In this regard, the signals received via the FM radio receiver may be processed by the APU 218 for conversion to an appropriate signal format and/or encoding. Exemplary processing may comprise analog-to-digital conversion by the A/D 224 and/or digital-to-analog conversion by the D/A 228. Additionally, the codec 220 in the APU 218 may perform SBC coding or other A2DP compliant audio coding for transportation of the FM radio data over a Bluetooth A2DP link. The processor system 202 and/or APU 218 may also enable performing continuous variable slope delta (CVSD) modulation, log pulse code modulation (Log PCM), and/or other Bluetooth compliant voice coding for transportation of FM radio data on Bluetooth synchronous connection-oriented (SCO) or extended SCO (eSCO) links.

The chip 200 may receive Bluetooth signals via the Bluetooth core 206. In this regard, the Bluetooth core 206 may process received Bluetooth signals and may make any resulting digital audio and/or data available to the chip 200. In this regard, received Bluetooth signals may, for example, comprise MP3 or AAC digital audio. The Chip 200 may re-transmit the received information via the PTU 204, the Bluetooth core 206, the APU 218, and/or the FM radio transmitter 208. In this regard, the signals received via the Bluetooth core 206 may be processed by the APU 218 for conversion to an appropriate signal format and/or encoding. Exemplary processing may comprise analog-to-digital conversion by the A/D 224 and/or digital-to-analog conversion by the D/A 228. Additionally, the codec 220 in the APU 218 may perform SBC coding or other A2DP compliant audio coding for transportation of the FM radio data over a Bluetooth A2DP link. The processor system 202 and/or APU 218 may also enable performing continuous variable slope delta (CVSD) modulation, log pulse code modulation (Log PCM), and/or other Bluetooth compliant voice coding for transportation of FM radio data on Bluetooth synchronous connection-oriented (SCO) or extended SCO (eSCO) links.

The chip 200 may receive digital and/or analog signals via the PTU 204. In this regard, the PTU 204 may make any received analog and/or digital audio and/or data available to the chip 200. Exemplary signals received by the PTU 204 may comprise digital audio and/or analog audio. The Chip 200 may re-transmit the received information via the PTU 204, the Bluetooth core 206, the APU 218, and/or the FM radio transmitter 208. In this regard, the signals received via the PTU 204 may be processed by the APU 218 for conversion to an appropriate signal format and/or encoding. Exemplary processing may comprise analog-to-digital conversion by the A/D 224 and/or digital-to-analog conversion by the D/A 228. Additionally, the codec 220 in the APU 218 may perform SBC coding or other A2DP compliant audio coding for transportation of the FM radio data over a Bluetooth A2DP link. The processor system 202 and/or APU 218 may also enable performing continuous variable slope delta (CVSD) modulation, log pulse code modulation (Log PCM), and/or other Bluetooth compliant voice coding for transportation of FM radio data on Bluetooth synchronous connection-oriented (SCO) or extended SCO (eSCO) links.

FIG. 3A is a block diagram illustrating a shared audio processor in an integrated FM radio and Bluetooth system, in accordance with an embodiment of the invention. Referring to FIG. 3A, there is shown an FM radio receiver 302, a Bluetooth receiver 308, an audio processor 300, a FM radio transmitter 316, and a Bluetooth transmitter 310.

The FM radio receiver 302 may comprise suitable logic, circuitry, and/or code that may enable receiving and extracting information from FM RF signals. In this regard, The FM radio receiver 302 may support amplification, mixing, filtering, and/or demodulation operations of FM and/or FMMPX stereo audio signals, for example. Accordingly, the FM radio receiver 302 may receive one or more control signals from a processor, such as the processor 202 disclosed in FIG. 2A. Also, the FM radio receiver 302 may comprise one or more local oscillators such as the LO 227. In an exemplary embodiment of the invention, the FM radio receiver 302 may enable reception of frequencies over the “FM broadcast band”, or approximately 76 MHz to 108 MHz. Additionally, the FM radio receiver 302 may, for example, enable outputting baseband audio comprising, for example, a left audio signal, a right audio signal, and/or RBDS data. In this regard, the FM radio receiver 302 may enable demodulating a RBDS modulated sub-carrier and outputting a digital RBDS datastream.

The Bluetooth receiver 308 may comprise suitable logic, circuitry, and/or code that may enable reception of Bluetooth transmissions, processing received Bluetooth signals, and outputting a resulting digital data-stream. For example, the Bluetooth receiver 308 may enable reception of A2DP data from a remote Bluetooth transmitter, processing of received A2DP data, and outputting a digital audio stream. In this regard, the digital audio stream may, for example, be MP3 or AAC encoded. The Bluetooth receiver 308 may receive one or more control signals from a processor, such as the processor 202 disclosed in FIG. 2A. Also, the Bluetooth receiver 308 may comprise one or more local oscillators such as the LO 227.

The Bluetooth transmitter 310 may comprise suitable logic, circuitry, and/or code that may enable transmitting Bluetooth signals. In this regard, the Bluetooth transmitter 310 may enable receiving digital data, formatting data, and transmitting data to a remote Bluetooth receiver. For example, the Bluetooth transmitter 310 may be enabled to receive MP3 or MC digital audio and transmit the stream as an A2DP datastream. The Bluetooth transmitter 310 may receive one or more control signals from a processor, such as the processor 202 disclosed in FIG. 2A. Also, the Bluetooth transmitter 310 may comprise one or more local oscillators such as the LO 227.

The FM radio transmitter 316 may comprise suitable circuitry, logic, and/or code that may enable frequency modulation and/or transmission of FM signals. In this regard, the FM radio transmitter 226 may support modulation, filtering, mixing, and/or amplification operations for FM radio and/or FM MPX stereo audio. In an exemplary embodiment of the invention, the FM radio transmitter may be enabled to modulate one or more subcarriers, for example, by a digital RBDS signal. The FM radio transmitter may also be enabled to combine of one or more analog signals with one or more modulated subcarriers to create, for example, an FM multiplex. Additionally, the FM radio transmitter may be enabled to frequency modulate analog signals, such as an FM multiplex, onto an RF carrier and output the modulated carrier to an antenna for transmission to a remote FM radio receiver. The FM radio transmitter 316 may receive one or more control signals from a processor, such as the processor 202 disclosed in FIG. 2A. Also, the FM radio transmitter 316 may comprise one or more local oscillators such as the LO 227.

The audio processor 300 may comprise suitable logic, circuitry, and/or code that may enable processing digital and/or analog audio signals. In this regard, the processor 300 may be enabled to filter, equalize, compress, decompress, convert, format, packetize, rate convert, and/or otherwise process analog and digital audio signals.

In an exemplary operation, one or more analog audio signals may be received by the audio processor 300 from the FM radio receiver 302. The audio processor 300 may operate on the analog audio and may output corresponding PCM audio, analog audio, and/or encoded (e.g. MP3 or AAC) digital audio. In this regard, the processor 300 may, for example, perform signal processing to improve, enhance, and/or modify the audio content. Additionally, the audio processor 300 may convert the received analog audio to a digital format. The various audio signals may be made available locally through an interface such as the PTU 204 of FIG. 2. The analog audio may be transferred to the FM radio transmitter 316 where it may be combined with RBDS or other data to generate a FM Multiplex. The digital audio may also be transferred to the Bluetooth transmitter 310 for retransmission to a remote device. In this regard, the Bluetooth transmitter 310 may transmit the digital audio as A2DP audio.

In another exemplary operation, one or more digital audio signals may be received by the audio processor 300 from the Bluetooth receiver 310. The audio processor 300 may operate on the digital audio and may output corresponding PCM audio, analog audio, and/or encoded (e.g. MP3 or AAC) digital audio. In this regard, the processor 300 may, for example, perform signal processing to improve, enhance, and/or modify the audio content. Additionally, the audio processor 300 may, for example, convert digital audio to analog audio or convert digital audio in a first format to digital audio in a second format. The various audio signals may be made available locally through an interface such as the PTU 204 of FIG. 2. The digital audio may also be transferred to the Bluetooth transmitter 310 for retransmission to a remote device. In this regard, the Bluetooth transmitter 310 may transmit the digital audio as A2DP audio. The analog audio may be transferred to the FM radio transmitter 316 where it may be combined with RBDS or other data to generate a FM Multiplex. Accordingly, the FM multiplex may be modulated onto an RF carrier which is then transmitted to a remote FM radio receiver.

In another exemplary embodiment of the invention, analog and/or digital audio may be received by the audio processor 300 from a local source via an interface such as the PTU 204 disclosed in FIG. 2. The audio processor 300 may operate on the audio and may output corresponding PCM audio, analog audio, and/or encoded (e.g. MP3 or MC) digital audio. In this regard, the processor 300 may, for example, perform signal processing to improve, enhance, and/or modify the audio content. Additionally, the audio processor 300 may, for example, convert analog audio to digital audio, digital audio to analog audio, or digital audio in a first format to digital audio in a second format. The various audio signals may be made available locally through an interface such as the PTU 204 of FIG. 2. The digital audio may also be transferred to the Bluetooth transmitter 310 for retransmission to a remote device. In this regard, the Bluetooth transmitter 310 may transmit the digital audio as A2DP audio. The analog audio may be transferred to the FM radio transmitter 316 where it may be combined with RBDS or other data to generate a FM Multiplex. Accordingly, the FM multiplex may be modulated onto an RF carrier which is then transmitted to a remote FM radio receiver.

FIG. 3B is a block diagram illustrating an exemplary integrated audio processor, in accordance with an embodiment of the invention. Referring to FIG. 3B, the audio processor 300 may comprise an A/D 304, an audio encoder 306, an audio decoder 312, a D/A 314, and a plurality of switching elements 316.

The A/D 304 may comprise suitable logic, circuitry, and/or code that may enable conversion of analog signals to a digital representation. In this regard, the A/D 304 may, for example, sample and quantize an input analog signal at times specified by a sample clock to output a PCM signal. Accordingly, the A/D 304 may receive one or more control signals from, for example, a processor such as the CPU 210 of FIG. 2A. Moreover, the A/D 304 may receive one or more clock signals from, for example, a local oscillator such as the LO 227 in FIG. 2A.

The audio encoder 306 may comprise suitable logic, circuitry, and or code that may, for example, enable conversion of PCM data to one or more digital audio formats. In this regard, the audio encoder may be, for example, an SBC audio encoder, an MPEG 1, 2 audio encoder, and MPEG 2, 4 advanced audio coding (MC) encoder, an Advanced Range Testing, Reporting, and Control (ARTRAC) audio encoder, or other suitable audio encoder. The audio encoder 306 may receive one or more control signals from, for example, a processor such as the CPU 210 of FIG. 2, and/or one or more clock signals from, for example, a local oscillator such as the LO 227 in FIG. 2A. In one embodiment of the invention, the audio encoder 306 may be a variable rate audio encoder and may receive a line speed control signal from a line speed control algorithm comprising, for example, a Bluetooth core such as the Bluetooth Tx block 310 of FIG. 3A. Similarly, the audio encoder 306 may comprise a rate adaptor that may enable controlling the encoding rate, for example, of FM radio audio received from the FM radio Rx block 302. The audio encoder may adapt the output sampling rate of the audio paths to the sampling clock of a remote device when a digital audio interface is used to transport the encoded data. Accordingly, the audio encoder 306 may comprise one or more buffers that may enable sample rate conversion.

The audio decoder 312 may comprise suitable logic, circuitry, and/or code that may enable the removal of encoding and/or formatting associated with digital audio formats. In this regard, audio decoder 312 may be, for example, an SBC audio decoder, an MPEG 1, 2 audio decoder, and MPEG 2, 4 advanced audio coding (MC) decoder, an Advanced Range Testing, Reporting, and Control (ARTRAC) audio decoder, or other suitable audio decoder. The audio decoder 312 may receive one or more control signals from, for example, a processor such as the CPU 210 of FIG. 2, and/or one or more clock signals from, for example, a local oscillator such as the LO 227 in FIG. 2A. In one embodiment of the invention, the audio decoder 312 may be a variable rate audio decoder and may receive a line speed control signal from a line speed control algorithm comprising, for example, a Bluetooth core such as the Bluetooth Tx block 310 of FIG. 3A. Similarly, the audio decoder 312 may comprise a rate adaptor that may enable controlling the decoding rate, for example, of digital audio received from the BT Rx block 308. The audio decoder may adapt the output sampling rate of the audio paths to the sampling clock of a remote device when a digital audio interface is used to transport the decoded data. Accordingly, the audio encoder 306 may comprise one or more buffers that may enable sample rate conversion.

The D/A 314 may comprise suitable logic, circuitry, and/or code that may enable conversion of digital signals to an analog representation. In this regard, the D/A 314 may, for example, output a voltage proportional to the binary value of an input digital signal. Accordingly, the D/A 314 may receive one or more control signals from, for example, a processor such as the CPU 210 of FIG. 2A. Moreover, the A/D 304 may receive one or more clock signals from, for example, a local oscillator such as the LO 227 in FIG. 2A.

The switching elements 316 may comprise suitable logic, circuitry, and/or code that may enable coupling and decoupling, in various configurations, the nodes connected to each switching element 316. In this regard, the switching elements 316 may enable controlling the path of signals through the audio processor 300. The signal paths may be configured based on the desired input and output audio signals. Accordingly, the switching elements 316 may receive one or more control signals from a processor, such as the processor 210 disclosed in FIG. 2.

The filtering/equalization/DSP block 318 may comprise suitable logic, circuitry, and/or code that may enable filtering, equalization, enhancing, correcting, and/or otherwise processing audio signals. In one embodiment of the invention, the filtering/equalization/DSP block 318 may comprise a digital filter that may combine de-emphasis, bass, and/or treble adjustments. The digital filter may have a programmable audio bandwidth, for example. Accordingly, the filtering/equalization/DSP block 318 may enable tonal presets that, for example, adjust levels of bass, treble, and mid range frequencies to suit a particular type of audio. For example, presets such as “rock”, “voice”, and/or “classical” may be set in the filtering/equalization/DSP block 318. In various embodiments of the invention the filtering/equalization/DSP block 318 may be implemented as an autonomous block in the audio processor 300, or may be integrated, in whole or in part, into the other various blocks of the audio processor 300.

In operation, the audio processor 300 may be highly configurable and may provide a multitude of options as far as input signal type/format and output signal type/format. The audio processor 300 may enable inputting a plurality of signals which may include PCM data, encoded audio data, and/or baseband analog signals. In this regard, the PCM data may be an uncompressed digital audio stream, the encoded audio data may be, for example, MP3 and/or MC formatted, and the baseband analog signals may be, for example, left and/or right audio signals. The audio processor may thus convert between PCM audio, encoded audio, and/or analog audio. Additionally, the audio processor may be configured to convert from one encoding scheme to another, for example MP3 to MC. Moreover, the audio processor 300 may output multiple signal types/formats from a single input type/format.

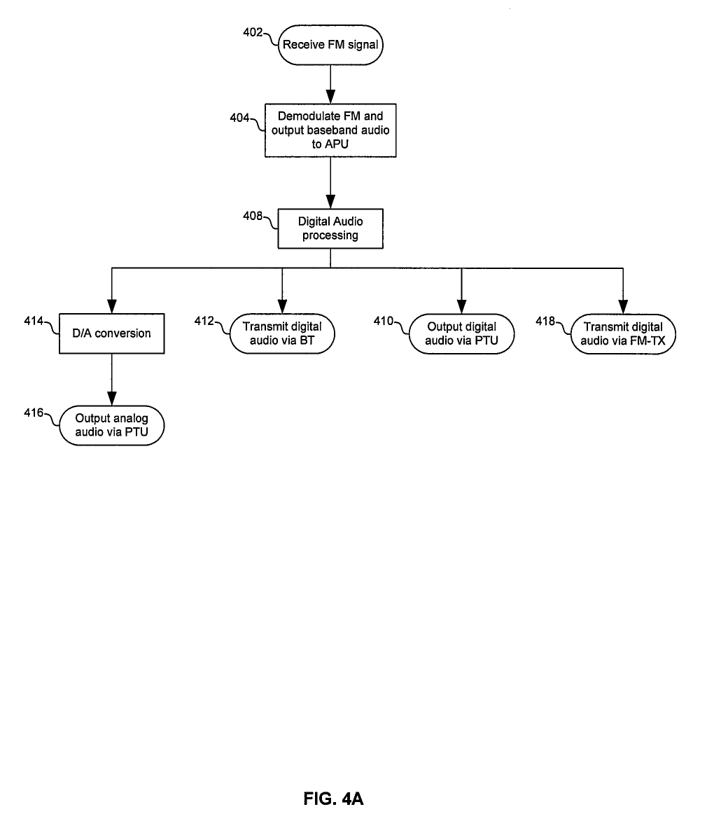

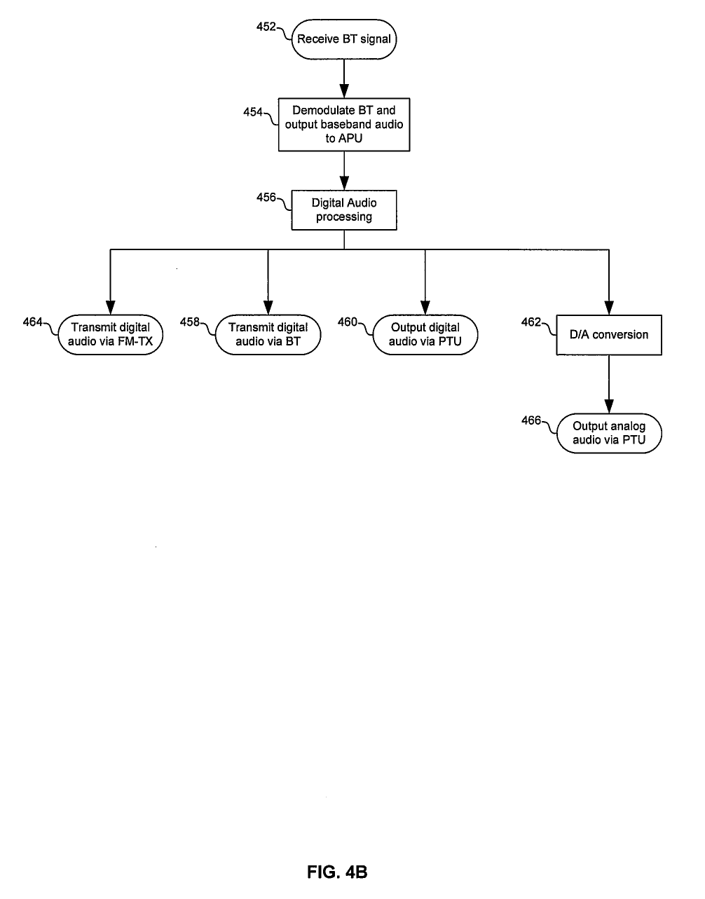

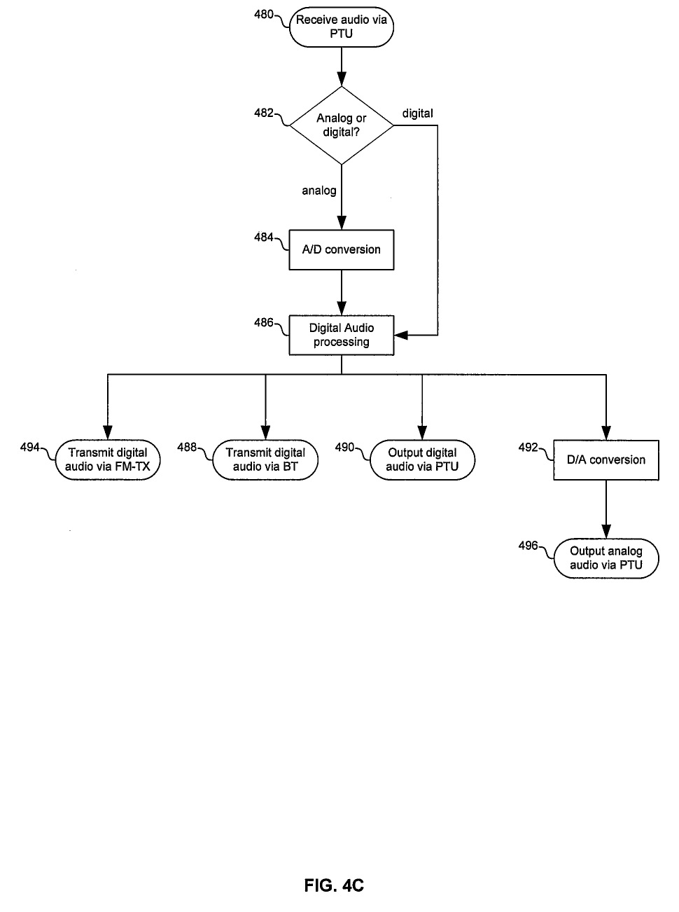

FIG. 4A illustrates exemplary steps for processing audio received audio via an integrated FM radio receiver utilizing a shared audio processor, in accordance with an embodiment of the invention. Referring to FIG. 4A the exemplary steps may begin with step 402 when an FM radio signal may be received by a FM radio receiver such as the FM radio receiver 302. In step 404 the FM radio receiver may demodulate the received FM radio signal to generate a baseband digital audio signal. In step 408, the digital audio signal may be, for example, filtered, equalized, and/or encoded by an audio processor such as the APU 300.

Subsequent to step 408, one or more of steps 410 through 418 may be executed depending on a desired audio format and/or transmission method. In step 410 the digital audio signal may be output locally via an interface such as the PTU 204. In this regard, a digital audio stream may be output, for example, to a hard drive or other storage device. In step 412 the digital audio signal may be transmitted via a Bluetooth transmitter such as the Bluetooth transmitter 310. In this regard, the digital audio may be transmitted to a listening device such as the listening device 108 in FIG. 1. In step 414 the digital audio signal may be converted to analog by a D/A converter such as the D/A converter 314. In step 416 the analog audio signal may be output locally via an interface such as the PTU 204. In this regard, the analog audio may be output, for example, to one or more speakers. In step 418 the analog audio signal may be transmitted via an FM radio transmitter such the FM radio transmitter 316. In this regard, received audio may, for example, be processed and re-transmitted, possibly on a different frequency than the received FM radio signal.

FIG. 4B illustrates exemplary steps for processing audio received audio via an integrated BT receiver utilizing a shared audio processor, in accordance with an embodiment of the invention. Referring to FIG. 4B the exemplary steps may begin with step 452 when a Bluetooth signal is received by a Bluetooth receiver such as the Bluetooth receiver 308. In step 454 the Bluetooth receiver may demodulate the received Bluetooth signal to output a baseband digital audio signal. In step 456, the digital audio signal may be, for example, filtered, equalized, and/or encoded by an audio processor such as the APU 300.

Subsequent to step 456, one or more of steps 458 through 466 may be executed depending on a desired audio format and/or transmission method. In step 458 the digital audio may be transmitted via a Bluetooth transmitter such as the Bluetooth transmitter 310. In this regard, the digital audio may be transmitted to a listening device such as the listening device 108 in FIG. 1. In step 460 the digital audio signal may be output locally via an interface such as the PTU 204. In this regard, a digital audio stream may be output, for example, to a hard drive or other storage device. In step 462 the digital audio signal may be converted to analog by a D/A converter such as the D/A converter 314. In step 464 the digital audio signal may be transmitted via a FM radio transmitter such as the FM radio transmitter 316. In this regard, the received audio may, for example, be transmitted to an FM radio receiver such as the FM radio receiver 110 in FIG. 1. In step 466 the analog audio signal may be output locally via an interface such as the PTU 204. In this regard, the analog audio may be output, for example, to one or more speakers.

FIG. 4C illustrates exemplary steps for processing audio received audio via an integrated PTU utilizing a shared audio processor, in accordance with an embodiment of the invention. Referring to FIG. 4C the exemplary steps may begin with step 480 when an audio signal may be received by a peripheral transport unit, such as the PTU 204. In step 482 it may be determined whether the audio signal received by the PTU comprises analog or digital audio. In instances that the audio signal received by the PTU may be digital, the exemplary steps may advance to step 486.

Returning to step 482, in instances that the audio signal received by the PTU may be analog, the exemplary steps may advance to step 484. In step 484, the received analog audio signal may be converted to a digital representation. Subsequent to step 484, the exemplary steps may advance to step 486.

In step 486, the audio signal may be demodulated to generate a baseband digital audio signal. In step 486, the digital audio signal may be, for example, filtered, equalized, and/or encoded by an audio processor such as the APU 300.

Subsequent to step 486, one or more of steps 488 through 496 may be executed depending on a desired audio format and/or transmission method. In step 488 the digital audio may be transmitted via a Bluetooth transmitter such as the Bluetooth transmitter 310. In this regard, the digital audio may be transmitted to a listening device such as the listening device 108 in FIG. 1. In step 490 the digital audio signal may be output locally via an interface such as the PTU 204. In this regard, a digital audio stream may be output, for example, to a hard drive or other storage device. In step 492 the digital audio signal may be converted to analog by a D/A converter such as the D/A converter 314. In step 494 the digital audio signal may be transmitted via a FM radio transmitter such as the FM radio transmitter 316. In this regard, the received audio may, for example, be transmitted to an FM radio receiver such as the FM radio receiver 110 in FIG. 1. In step 496 the analog audio signal may be output locally via an interface such as the PTU 204. In this regard, the analog audio may be output, for example, to one or more speakers.

Aspects of the invention may enable processing Bluetooth audio signals and FM radio audio signals utilizing a shared audio processor, such as the audio processor 218 in FIG. 2 and the audio processor 300 in FIGS. 3A and 3B. The shared audio processor may enable A/D conversion utilizing, for example, an A/D converter such as the A/D converter 224 of FIG. 2A or the A/D converter 304 of FIG. 3B. The shared audio processor may enable D/A conversion utilizing, for example, an D/A converter such as the D/A converter 228 of FIG. 2A or the D/A converter 314 of FIG. 3B. The shared audio processor may enable converting between digital audio formats utilizing, for example, a audio encoder such as the audio encoder 306 and/or audio decoder 312 of FIG. 3B. The shared audio processor may process signals from a FM radio receiver such as the FM radio receiver 302 and/or the Bluetooth receiver 308 of FIG. 3A. The shared audio processor may process signals to be transmitted by a FM radio transmitter such as the FM radio receiver 302 or the Bluetooth transmitter 310 of FIG. 3A. The shared audio processor may process analog and/or digital signals. The shared audio processor may process encoded signals.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing signals in a communication system, the method comprising:
in an integrated FM radio and Bluetooth communication system:
processing Bluetooth audio signals utilizing an audio processor; and
processing FM audio signals utilizing said audio processor.

2. The method according to claim 1, comprising converting said Bluetooth audio signals from analog signals to digital audio signals.

3. The method according to claim 1, comprising converting said Bluetooth audio signals from digital signals to analog audio signals.

4. The method according to claim 1, comprising converting said FM audio signals from analog signals to digital audio signals.

5. The method according to claim 1, comprising converting said FM audio signals from digital signals to analog audio signals.

6. The method according to claim 1, comprising converting digital audio signals of a first format to digital audio signals of a second format.

7. The method according to claim 1, comprising performing A2DP compliant audio encoding for transmission of FM data over a Bluetooth link.

8. The method according to claim 1 comprising performing Bluetooth compliant voice encoding for transmission of voice data over a Bluetooth link.

9. The method according to claim 8, comprising performing continuous variable slope delta (CVSD) modulation of said voice data.

10. The method according to claim 8, comprising performing log pulse code modulation (Log PCM) of said voice data.

11. A machine-readable storage having stored thereon, a computer program having at least one code section for processing signals in a communication system, the at least one code section being executable by a machine for causing the machine to perform steps comprising:
in an integrated FM and Bluetooth communication system:
processing Bluetooth audio signals utilizing an audio processor; and
processing FM audio signals utilizing said audio processor.

12. The machine-readable storage according to claim 11, wherein said at least one code section comprises code for converting said Bluetooth audio signals from analog signals to digital audio signals.

13. The machine-readable storage according to claim 11, wherein said at least one code section comprises code for converting said Bluetooth audio signals from digital signals to analog audio signals.

14. The machine-readable storage according to claim 11, wherein said at least one code section comprises code for converting said FM audio signals from analog signals to digital audio signals.

15. The method according to claim 11, wherein said at least one code section comprises code for converting said FM audio signals from digital signals to analog audio signals.

16. The machine-readable storage according to claim 11, wherein said at least one code section comprises code for converting digital audio signals of a first format to digital audio signals of a second format.

17. The machine-readable storage according to claim 11, wherein said at least one code section comprises code for performing A2DP compliant audio encoding for transmission of FM data over a Bluetooth link.

18. The machine-readable storage according to claim 11, wherein said at least one code section comprises code for performing Bluetooth compliant voice encoding for transmission of voice data over a Bluetooth link.

19. The machine-readable storage according to claim 18, wherein said at least one code section comprises code for performing continuous variable slope delta (CVSD) modulation of said voice data.

20. The machine-readable storage according to claim 18, wherein said at least one code section comprises code for performing log pulse code modulation (Log PCM) of said voice data.

21. A system for processing signals in a communication system, the system comprising:
an integrated FM and Bluetooth communication system comprising a single audio processor, wherein said shared audio processor processes Bluetooth audio signals and processes FM audio signals.

22. The system according to claim 21, wherein said shared audio processor converts said Bluetooth audio signals from analog signals to digital audio signals.

23. The system according to claim 21, wherein said shared audio processor converts said Bluetooth audio signals from digital signals to analog audio signals.

24. The system according to claim 21, wherein said shared audio processor converts said FM audio signals from analog signals to digital audio signals.

25. The system according to claim 21, wherein said shared audio processor converts said FM audio signals from digital signals to analog audio signals.

26. The system according to claim 21, wherein said shared audio processor converts digital audio signals of a first format to digital audio signals of a second format.

27. The system according to claim 21, wherein said shared audio processor performs A2DP compliant audio encoding for transmission of FM data over a Bluetooth link.

28. The system according to claim 21 wherein said shared audio processor performs Bluetooth compliant voice encoding for transmission of voice data over a Bluetooth link.

29. The system according to claim 28, wherein said shared audio processor performs continuous variable slope delta (CVSD) modulation of said voice data.

30. The system according to claim 28, wherein said shared audio processor performs log pulse code modulation (Log PCM) of said voice data.
